(19) United States
(12) Patent Application Publication
(10) Pub. No.: US 2012/0215652 A1
(43) Pub. Date: Aug. 23, 2012

(54) MARKETPLACE FOR SENSOR DATA FROM MOBILE DEVICES AND ITS ABSTRACTIONS

(75) Inventors: Iain Melvin, Princeton, NJ (US); Murugan Sankaradas, Dayton, NJ (US); Yun Chi, Monte Sereno, CA (US); Hojjat Jafarpour, San Carlos, CA (US)

(73) Assignee: NEC Laboratories America, Inc., Princeton, NJ (US)

(21) Appl. No.: 13/399,419

(22) Filed: Feb. 17, 2012

Related U.S. Application Data
(60) Provisional application No. 61/444,350, filed on Feb. 18, 2011.
(60) Provisional application No. 61/474,792, filed on Apr. 13, 2011.

(51) Int. Cl. G06Q 30/06; G06F 17/30

(52) U.S. Cl. 705/26.1; 707/769; 707/E17.014

(57) ABSTRACT

Systems and methods for the exchange of sensor data and its abstractions include one or more service hubs, including a first service hub. A query input is configured to receive a query that makes requests for sensor data on at least one of the one or more service hubs and receives processed sensor data as a context of at least one user of a mobile device. In response to a request for processed sensor data, the first service hub is configured to request sensor data from one or more mobile devices by sending a request to be scheduled by an application executed on the one or more mobile devices. The first service hub is further configured to process the sensor data and return the processed sensor data to at least one of the query and a higher-level service hub.

### RELATED APPLICATION INFORMATION

This application claims priority to provisional application Ser. No. 61/444,350 filed Feb. 18, 2011 and provisional application Ser. No. 61/474,792 filed Apr. 13, 2011, both incorporated herein by reference in their entirety.

### BACKGROUND

1. Technical Field

The present invention relates to polling and processing sensor data, and more specifically, to polling and processing sensor data of mobile devices according to context for the purposes of buying and selling high-level sensor data.

2. Description of the Related Art

The problem of establishing real-time high-level knowledge of the context of mobile device (e.g., cell phone) users from the sensor data of their mobile devices is considered. High-level context information may be useful for businesses to, e.g., create targeted advertisements or develop marketing strategies tailored to end users. For example, mobile device sensor data may be polled and processed to provide high-level interpretations such as “who will be the next president of the United States,” which may be useful to businesses who perform voter surveys, or “how many people are running in the park,” which may be useful for healthcare companies or athletic shoe companies. However, gaining high-level context information from low-level sensor data requires many steps, and many end-users may have little motivation to share their personal information.

### SUMMARY

A system for the exchange of sensor data and its abstractions includes one or more service hubs, including a first service hub. A query input is configured to receive a query that makes requests for sensor data on at least one of the one or more service hubs and receives processed sensor data as a context of at least one user of a mobile device. In response to a request for processed sensor data, the first service hub is configured to request sensor data from one or more mobile devices by sending a request to be scheduled by an application executed on the one or more mobile devices. The first service hub is further configured to process the sensor data and return the processed sensor data to at least one of the query and a higher-level service hub.

A system for the exchange of sensor data and its abstractions includes one or more service hubs, including a first service hub. The one or more service hubs receive sensor data from at least one of a lower-level service hub and a mobile device in exchange for compensation. A query input is configured to receive a query and receive compensation, wherein the query makes requests for sensor data on at least one of the one or more service hubs and receives processed sensor data as a context of at least one user of a mobile device in exchange for compensation. In response to a request for processed sensor data, the first service hub is configured to request sensor data from one or more mobile devices by sending a request to be scheduled by an application executed on the one or more mobile devices. The request is scheduled such that compensation received is maximized and in accordance with user preferences. The first service hub is further configured to process the sensor data and return the processed sensor data to at least one of the query and a higher-level service hub.

A method for the exchange of sensor data and its abstractions includes providing one or more service hubs, including a first service hub. A query is received that makes requests for sensor data on at least one of the one or more service hubs. In response to a request for processed sensor data, the first service hub requests sensor data from one or more mobile devices by sending a request to be scheduled by an application executed on the one or more mobile devices. The first service hub processes the sensor data on the first service hub and returns the processed sensor data to at least one of the query and a higher-level service hub. Processed sensor data is received to the query as a context of at least one user of a mobile device.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a high-level overview of the system/method of the marketplace, in accordance with one embodiment;

FIG. 2 is a block/flow diagram showing the system/method of the marketplace, in accordance with one embodiment;

FIG. 3 is a block/flow diagram showing a detailed illustration of the system/method of the marketplace, in accordance with one embodiment;

FIG. 4 is a block/flow diagram showing an exemplary operation of the system/method of the marketplace as it relates to dynamic context, in accordance with one embodiment; and

FIG. 5 is a block/flow diagram showing a system/method of the marketplace, in accordance with one embodiment.

### DETAILED DESCRIPTION OF PREFERRED EMBODIMENTS

In accordance with the present principles, systems and methods are provided for a marketplace for buying and selling information gleaned from mobile device sensors. In one embodiment, interested parties construct a query in the marketplace to determine high-level information of mobile device users. Queries can be broken down into sub-queries that are serviced by service nodes. For example, an interested party can construct the query, “who is running in the park?” which can be broken down into the sub-queries “who is running?” and “who is in the park?” Service nodes will retrieve and process the information from other processing nodes or the mobile device sensors directly, adding value to the data at each node. Advantageously, in this manner, the present principles can poll for specific information that relates to a particular type of sensor data or complies with a constraint (i.e., no more than 5 minutes old) to provide a specific amount of data, as opposed to collecting a fixed amount of data and uploading it to a database at regular intervals. Queries can then combine information obtained from different service nodes to provide an answer to the query.

Advantageously, in a preferred embodiment, the marketplace includes a system of compensation (e.g., money). Some form of compensation is injected by the interested party upon execution of the query, and is used by service nodes to purchase processed information from other sensor nodes or sensor data directly from the mobile device. In this way, mobile device users are compensated for their personal information. The marketplace may, in one embodiment, autonomously sell raw sensor data in order to receive as much compensation for the user as possible, within the constraints of the user preferences.

In yet another embodiment, third-parties may enter and compete in the marketplace to provide service nodes with specialized analysis technology. These third parties add value to data coming from mobile device sensors or other service nodes. Third parties may advertise their services, accept orders, pay for data, and sell their processed data.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

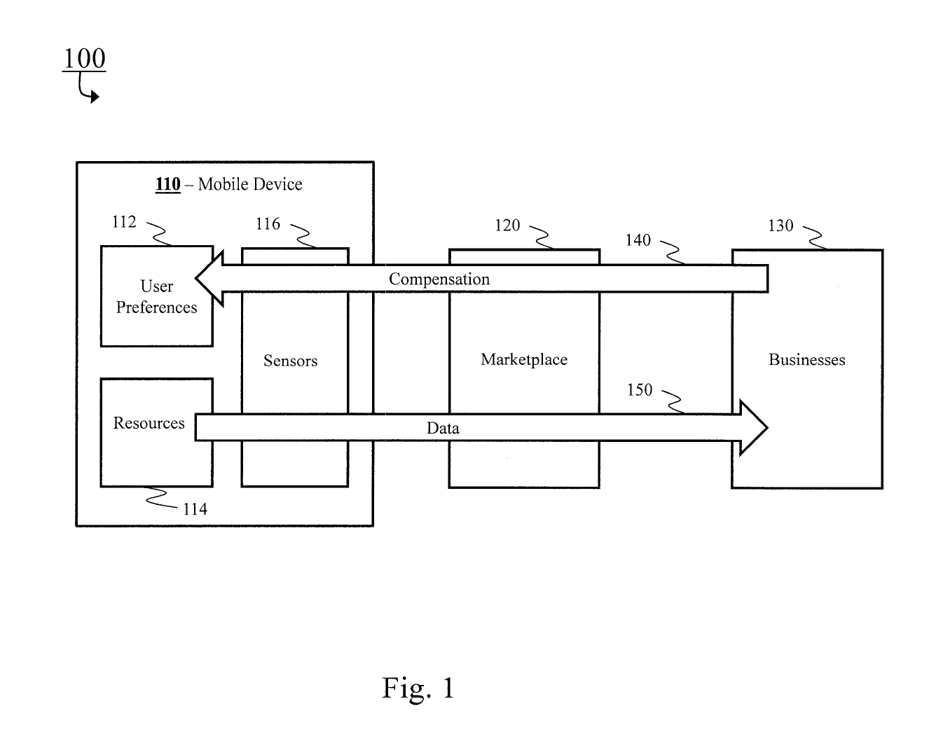

Referring now to the drawings in which like numerals represent the same or similar elements and initially to FIG. 1, a high-level overview of the system/method of the marketplace 100 is illustratively depicted in accordance with one embodiment. Marketplace 120 enables the buying and selling of high-level information gleaned from sensors 116 of one or more mobile devices 110 to interested parties, such as businesses 130. Mobile devices 110 may include, for example, but are not limited to, mobile phones, laptop computers, tablet computers, personal digital assistants, digital cameras, personal navigation devices, etc. Businesses 130, which include any interested party and even the mobile device user him/herself, can construct a query on phone context and run it in marketplace 120. For example, businesses 130 can construct a query to determine “which mobile device user is running in the park?” Marketplace 120 includes a network of middleware services that make queries on one another and on sensors 116 of mobile device 110.

It is to be noted that the present principles are not limited to mobile devices, but may in fact be applied to any type of device to process its context for any type of use. For example, the present principles may be applied to a television device to poll and process its sensors, which may include a microphone or camera, to obtain feedback as to the ratings of a particular advertisement or television show. Other applications are also contemplated.

Referring back to FIG. 1, businesses 130 who want to obtain market analytic data 150 from users' behavior run the query and inject some form of compensation 140 into the system along with their query. Compensation 140 is used by the middleware services of marketplace 120 to purchase processed data from other middleware services in marketplace 120, or to buy data from sensors 116 of mobile device 110. Where data from sensors 116 are required, the mobile device 110 user receives compensation 140 in exchange for data 150. Compensation 140 may be in the form of, but is not limited to, monetary benefits or discounted/free products and services, for example.

High-level queries can be broken down into lower-level sub-queries. For example, the query “which mobile device user is running in the park?” can be broken down into the sub-queries: “which mobile device users are running?” and “which mobile device users are in the park?” The high-level query connects to middleware service nodes of marketplace 120 to break down the high-level query and make requests on the middleware service nodes for the sub-queries.

The middleware service nodes of marketplace 120 may make requests on other service nodes in marketplace 120, which ultimately make different requests for data 150 on sensors 116 of mobile device 110. Sensors 116 may include, for example, but are not limited to, a Global Positioning Systems (GPS), Bluetooth™, accelerometers, cameras, microphones, etc. Users of mobile device 110 who are willing to share their personal data 150 can set a premium, such as an “ask” price, for each type of sensor data that their mobile device 110 provides. The “ask” price can be abstracted in the form of preset user preferences 112 of the user's mobile device 110. The “bid” price is determined by the market place, where businesses compete to obtain sensory data 150 from mobile devices 110. The market price for sensory data is expected to vary based on demand (i.e., requests for data analytics and interpretations from businesses 130) and supply (i.e., the number of users willing to share data 150 of a particular sensor 116 and their “ask” price).

It is noted that in order for a mobile device 110 to provide data 150 from sensors 116, mobile device 110 uses resources 114 to sample the data 150 from sensors 116 and upload it to the marketplace 120. Users of mobile device 110 may set a limit on the use of mobile device 110 resources 114 by configuring user preferences 112. Resources 114 may include, for example, battery, processing components, memory, etc. In the event that there are too many interested parties requesting data 150 from mobile device 110, such that user preferences 112 is overloaded, mobile device 110 schedules the requests for processing in a manner that maximizes compensation 140 for the user.

High-level assessment of contexts requires many levels of processing and abstraction, from the creation and processing of low-level features, such as image processing on pixels and audio filters on audio samples, to high-level semantic methods, such as object recognition and text analysis/search. There are numerous processing services contemplated, including, but not limited to, e.g., facial recognition, object recognition, action detection, location analysis, speech recognition, voice recognition, music recognition, optical character recognition, translation analysis, etc. It would be difficult for one lab or company to build a system covering all areas of expertise. It is contemplated that third parties with special analysis technology enter the marketplace 120 by creating service nodes to provide middleware processing services to extract data 150 in exchange for compensation 140. These service nodes add value to data 150 from sensors 116 or other service nodes. Third parties may advertise their service, accept orders, pay for data and sell the processed data.

Many of these processing services require a lot of processing power and system resources. While it is contemplated that some of the processing services run on mobile device 110, performance may be low and the impact on battery life, processing and memory (i.e., resources 114) may make some types of analysis prohibitive. It is, therefore, contemplated that processing services be hosted remotely via, e.g., cloud computing. However, it is also contemplated that processing services are performed on mobile device 110.

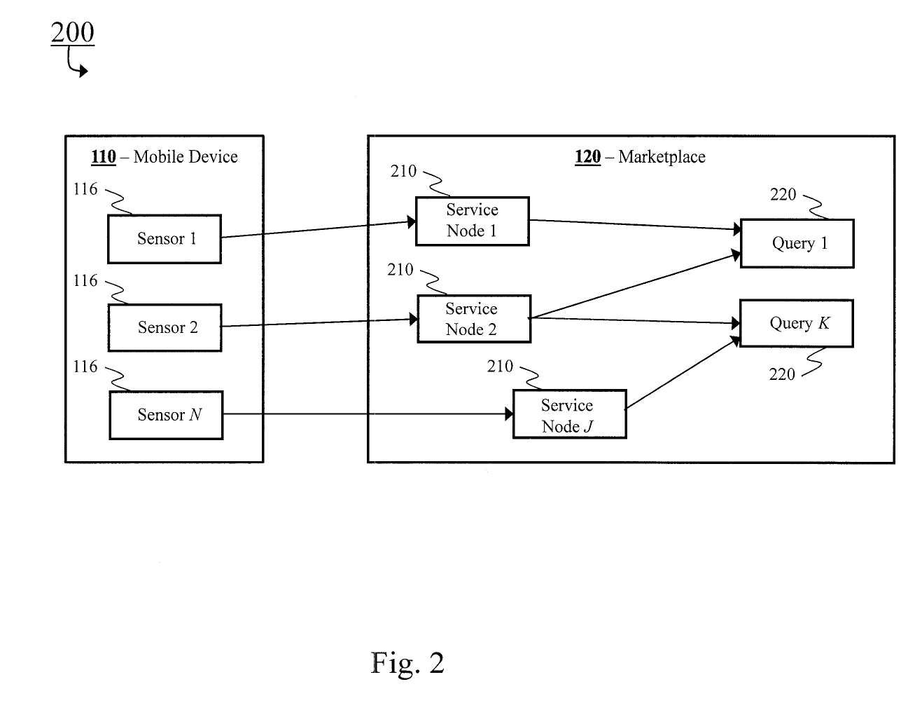

Referring now to FIG. 2, the system/method of the marketplace 200 is illustratively depicted in accordance with one embodiment. The system/method of the marketplace 200 includes one or more mobile devices 110 with sensors 116 connected to marketplace 120 through some connection (e.g., 3G/4G internet). Marketplace 120 includes one or more processing service nodes 210 and one or more queries 220. In one embodiment, service nodes 210 are hosted remotely via, e.g., cloud computing. Cloud computing refers to one or more services running on one or more machines connected together via some local or wide area network. In another embodiment, service nodes 210 are performed locally on mobile device 110. Queries are programs constructed to query services nodes 210 for information about the contexts of mobile device 110.

Businesses 130, as depicted in FIG. 1, interested in obtaining high-level knowledge of users of mobile device 110 first construct a query 220 and insert it into marketplace 120, as illustrated in FIG. 2. Upon execution of query 220, the interested businesses 130 inject some form of compensation (e.g., money) into marketplace 120, which represents the budget for making the query. Query 220 makes requests on services 210 in marketplace 120 using the budget to purchase processing services offered by services 210. Those services 210 will in turn pay for information from other services 210 or for sensor data from mobile device 110. Just as services nodes 210 can set a price for their services, so can users of mobile device 110 set a price for the acquisition of their data from sensors 116. It is further contemplated that users set restrictions on the kind of data they will allow, such as “no audio” or “location coordinates only to within half a mile.”

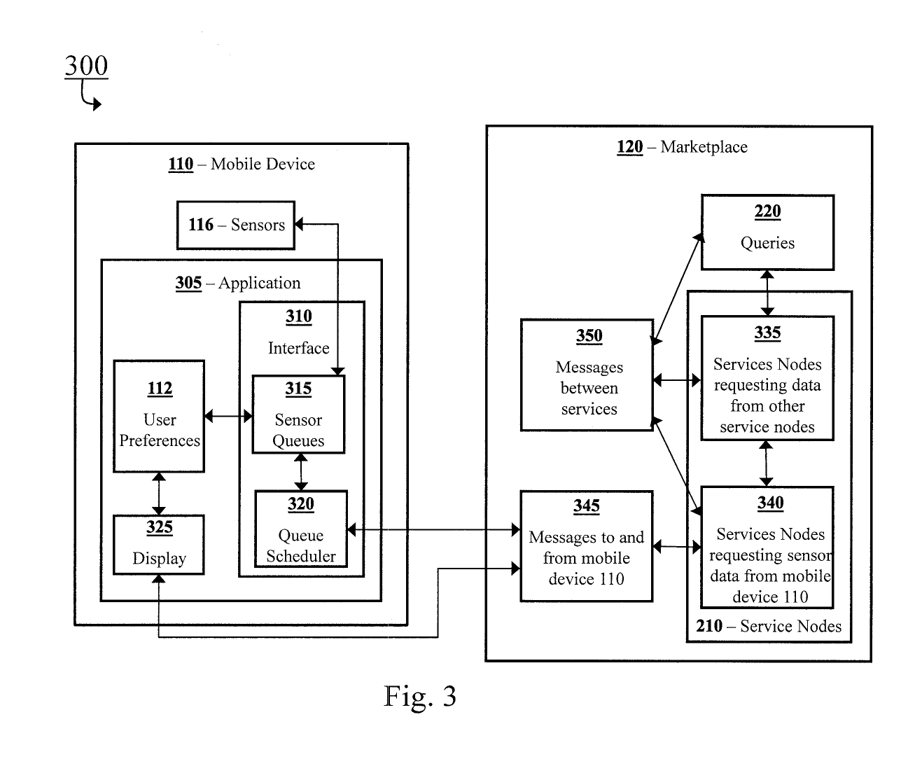

Referring now to FIG. 3, a detailed illustration of the system/method of the marketplace 300 is depicted, in accordance with one embodiment. The system/method of marketplace 300 includes one or more mobile devices 110 and marketplace 120. Mobile device 110 includes sensors 116 and an installed application 305. Application 305 manages user preferences 112 for pricing of sensor data and advertisements on display 325, and manages other constraints on sensors 116 and resources 114 (not shown in FIG. 3) of mobile device 110, such as “location coordinates to within a half a mile.” Display 403 serves requests for displaying an advertisement on mobile device 110. The cost for displaying an advertisement is set in user preferences 112.

Application 305 also handles requests for pricing and sensor data from marketplace 120 through interface 310 to respond to requests for sensor data, retrieve sensor data, deliver results and accept payment. Application 305 displays compensation received from marketplace 120. Application interface 402 includes sensor queues 315 and queue scheduler 320. Sensor queues 315 may be a set of queues to hold and process sensor requests, including queues for slow, regular and express processing. Queue scheduler 320 accepts requests for sensor data from marketplace 120 and places requests in queues 315. In one embodiment, scheduler 320 schedules requests in queues 315 such that the user receives the largest compensation, given the type of request and user preferences 112. It is noted that the use of queues 315 and scheduler 320 is one method to schedule many requests in order to optimize some objective, such as to maximize the financial return for the user. Other methods are also contemplated.

Marketplace 120 includes queries 220, which are constructed by interest parties, such as businesses 130 (of FIG. 1), who are interested in the combined results of one or more service nodes 210. Interested parties inject some form of compensation with queries 220 in a form of electronic payment system (e.g., bitcoin), representing the budget for the query. Queries 220 connect to other service nodes 210 to request pricing and high-level context data, which are processed from sensor data.

Service nodes 210 includes service nodes 330 that request sensor data from mobile device 110, and services nodes 335 that request services from other service nodes 335 and 330. Service nodes 335 that use other service nodes: receive requests for pricing and data from higher level service nodes 335 or queries 220; make requests and payments to other service nodes 335 for the results of their analysis; process acquired data to perform analysis; and return the results of the analysis to higher level service nodes 335 or queries 220. Service nodes 330 that request sensor data from mobile device 110: receive requests from service nodes 335 for a description and cost of a “data product” that it can generate; make requests on mobile device 110 in the form of messages 344 for sensor data; process sensor data; and send the product to a higher level service node 335 in exchange for compensation. In one embodiment, requests made onto service nodes 330 and 335 are in the form of a service level agreement indicating that if the information requested is returned within a specified time, the service node will receive compensation.

As noted above, messages 301 represent communication between marketplace 120 and mobile device 110. This may include: a request from service node 330 for the cost and characteristics of sensor information available on mobile device 110; a request from service node 330 for a specific kind of sensor data, accompanied by some form of compensation; and the requested sensor data from queue scheduler 320 of mobile device 110.

Marketplace 120 also includes messages 350 between services in marketplace 120, including service nodes 210 and queries 220. Similar to messages 345 between marketplace 120 and mobile device 110, messages 350 may include: a request from service node 335 or query 220 for the cost and characteristics of information available from the service; a request from service node 335 or query for data, accompanied by some form of compensation; and the requested data from service node 330 or service node 335, which may be processed data pertaining to one or more mobile devices 110.

Payment of the requests may be conditioned on receiving results within a set period of time or a minimum recall. For example, if a request is for an “action classification” on a subset of 1,000 mobile devices in a system, then a minimum recall requirement might be “get me the action classification of at least 500 mobile devices.”

In one embodiment, marketplace 120 includes an isolated datacenter. The datacenter may include a cluster of computers and/or virtual machines. The datacenter connects service nodes 210, which are, e.g., in the cloud, with a secure and trusted network. Information into and out of the secure network may be tightly controlled to protect user privacy. For example, allowed communication may include: 1) between the cloud (i.e., service nodes 210) and the mobile device 110; 2) for passing sensor requests to mobile device 110; 3) for passing personal data from mobile devices 110 to service nodes 210 in the cluster; 4) for passing compensation information to mobile device 110; 5) for the insertion of a service node 210 into the marketplace 120; 6) for the insertion of queries into marketplace 120, where queries may include query logic, compensation, and an advertising payload; 7) information about the advertisements delivered to the users from the query nodes 220; and 8) information about compensation payments to service nodes 210. For 1), 2), 3) and 4), a common protocol may be declared to ensure only approved communications (e.g., sensor requests and sensor data) only to the intended mobile devices 110. For 5) and 6), information is only permitted to enter the datacenter. For 7) and 8), this information would have to be tightly controlled and monitored to prevent information that may identify a user from being delivered to an advertiser. It is assumed that the datacenter is a trusted network and that data coming out of it does not hold any information that might identify a user.

It is further contemplated that queries 220 and service nodes 210 written by third parties would have to be submitted, in the form of code, to the marketplace 120. Marketplace 120 may require compliance with a licensing agreement to protect users' rights. This code may be reviewed before it is installed and executed on the system.

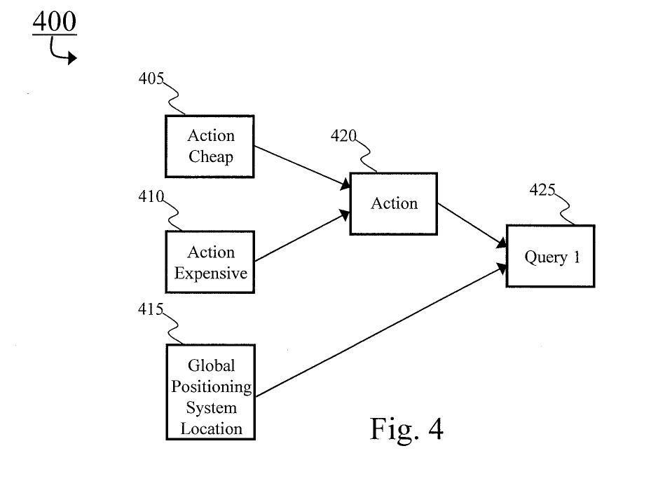

Referring now to FIG. 4, an exemplary operation of the system/method of the marketplace as it relates to dynamic context 400 is illustratively depicted, in accordance with one embodiment. A mobile device 110 moving throughout the day becomes more or less relevant to different high-level queries. That is, not all mobile devices 110 are relevant to all queries 220 at any one time. Thus, for a query 220 to be efficient, it should exclude as many mobile devices 110 that are not relevant from consideration and further processing as quickly and cheaply as possible to avoid unnecessary sensor data acquisition and/or processing. Marketplace 210 allows queries to use some “cheap” service nodes 210 to establish potential for relevance/context before making requests of “expensive” service nodes 210 for more accurate analysis of a particular mobile device 110.

For example, in FIG. 4, the query 425 of “who is running in the park?” may first request the services of action 420. Action 420 is a service that uses action cheap 405 and action expensive 410. Results of action cheap 405 are first requested to provide a rough initial assessment of the motion of a mobile device 110. The amount of data requested from the phone is low and thus cheap, but the accuracy of the classification is also low. Then results of action expensive 410 are requested to provide a very accurate assessment of the motion of a mobile device 110. The amount of data requested from the mobile device 110 is high and expensive, but enables accurate classification. By requesting and observing the rough results from action cheap 405, action 420 can request action expensive 410 classification only for mobile devices 110 that have, for example, even a slight possibility of matching the action requested by query 425. The results can then be applied to GPS Location 415, which provides very expensive coordinates from mobile device 110 and makes an assessment as to whether the coordinates are “in the park,” as in query 425. By requesting results from action 420 first, query 425 can limit the number of requests to mobile device 110 for GPS location 415. So in the example query 425 of “who is running in the park?,” many requests on mobile devices 110 and service nodes are made contingent on an initial (cheap) assessment of phone context.

It should be noted that a mobile device 110 with limited resources 114 will attempt to accommodate requests for sensor data 150 with higher compensation 140 before other requests. Therefore, if a query requires high recall (i.e., results from every phone) in a short time, then the budget for that query should also be high. In the event that the number of services 210 in the marketplace 120 grows and the number of real-time queries 220 grows, the demand for mobile device 110 data 150 will translate into higher compensation cost and, thus, efficiency in the marketplace leading to fewer direct demands on the sensor data will be a key factor for many businesses or other interested parties. If a service 210 is able to make an intelligent assessment of context from cheaply available data 150 before it commits to purchasing more expensive data on a case-by-case basis, then it can reduce its own running costs and improve the overall efficiency of the marketplace.

Caching services that specialize in storing historical data 150 may also be important. Service nodes 210 may be interested in a piece of sensor data for a particular mobile device 110 that is, e.g., “no more than 5 minutes old.” The service node 210 may ask a caching service for the sensor data instead of asking the mobile device 110 directly. If the caching service does not have the data, it can retrieve it from the mobile device 110 for some compensation 140, send it to the requesting service 210, and also store it in a database. Future requests for the same data 150 from the same mobile device 110 (e.g., requests for data no more than 10 minutes old) can be served from the database at no additional cost to the caching service. The caching service would be able to offer the data at a lower price to many services 210 than the price paid and still make a profit.

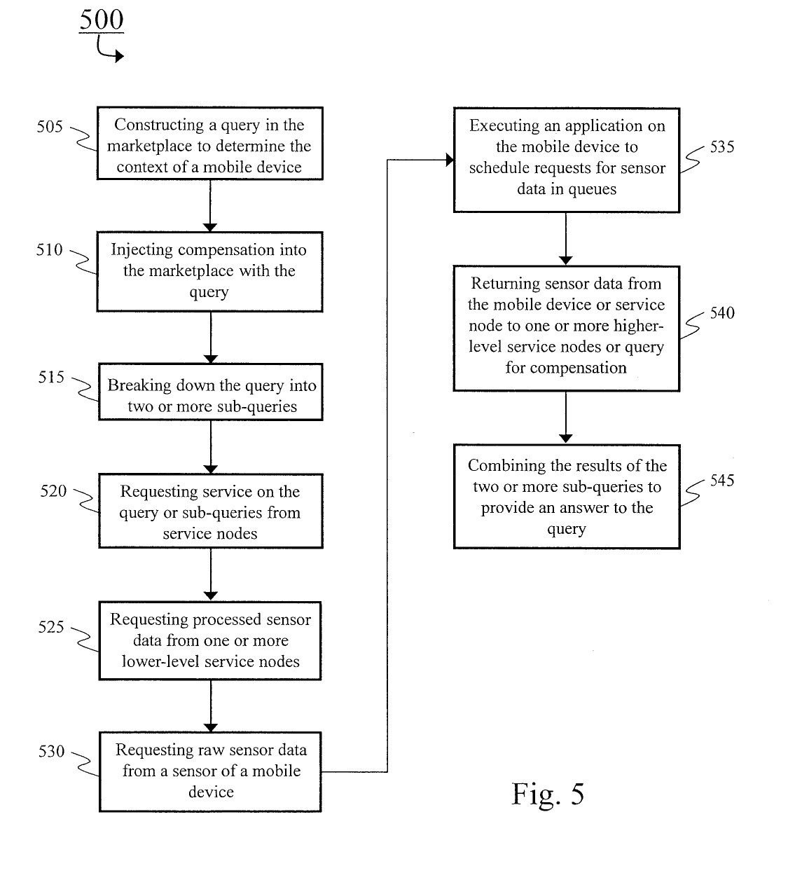

Referring now to FIG. 5, a block/flow diagram showing a system/method of the marketplace 500 is illustratively depicted in accordance with one embodiment. In block 505, a query is constructed in the marketplace to determine a context of a mobile device. The query may be constructed by a party interested in obtaining high-level information on the users of a mobile device, such as businesses 130 (in FIG. 1). Some form of compensation is injected into the marketplace upon execution of the query, in block 510. Compensation may include, e.g., money or discounted/free goods and services. The injected compensation represents the budget for determining the query. If appropriate, the query is broken down into two or more sub-queries, in block 515. For example, the query, “who is running in the park?” can be broken down into the sub-queries “who is running?” and “who is the in the park?”

In block 520, each query or sub-query makes requests on one or more service nodes. In one embodiment, the service nodes are created by third-parties who enter and compete in the marketplace by providing special analysis technology. The third-parties may advertise their service, accept orders, pay for data and sell processed data. In another embodiment, the service nodes may include a caching service that specializes in storing historical data. The caching service may provide historical data to a requesting service node at a lower cost than what it paid.

In block 525, if applicable, a service node may request processed sensor data from one or more lower-level service nodes. Alternatively, in block 530, a service node may request raw sensor data from a sensor of a mobile device. Requests may be in the form of a service level agreement indicating that if data can be delivered within the specified time limit, the service node or mobile device will be compensated. In one embodiment, a query or service node will request data from a lower-level service node or the mobile device directly by first requesting cheaper data and assessing context relevance of mobile devices before requesting more expensive data. In this manner, a service node can limit the number of expensive requests.

Requests for raw sensor data of a mobile device, in block 530, are made to an application executed on the mobile device, in block 535. In one embodiment, the application schedules the requests in queues, which may include slow, regular and express queues. Other methods are also contemplated. In yet another embodiment, the requests are scheduled in way to maximize compensation for the user, while conforming to the constraints of the user preference and resources of the mobile device.

In block 540, sensor data is returned from the mobile device or a lower-level service node to a high-level service node up to the query in exchange for compensation. Compensation for raw sensor data is set by the user in the user preferences of the mobile device. In block 545, the query combines the results of the two or more sub-queries to provide high-level context information satisfying the query.

Having described preferred embodiments of systems and methods of a marketplace for sensor data from mobile devices and its abstractions (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A system for the exchange of sensor data and its abstractions, comprising:
one or more service hubs, including a first service hub; and
a query input configured to receive a query, wherein the query makes requests for sensor data on at least one of the one or more service hubs and receives processed sensor data as a context of at least one user of a mobile device,
wherein the first service hub is configured to:
responsive to a request for processed sensor data, request sensor data from one or more mobile devices by sending a request to be scheduled by an application executed on the one or more mobile devices, and
process the sensor data and return the processed sensor data to at least one of the query and a higher-level service hub.

2. The system as recited in claim 1, wherein:
the query input is further configured to receive compensation;
the query receives processed sensor data in exchange for compensation; and
the one or more service hubs receives sensor data from at least one of a lower-level service hub and the one or more mobile devices in exchange for compensation.

3. The system as recited in claim 1, wherein the request is scheduled such that compensation is maximized for the user.

4. The system as recited in claim 1, wherein the request is scheduled in accordance with user preferences of the mobile device.

5. The system as recited in claim 4, wherein user preferences include criteria on at least one of the type of sensor data, the accuracy of the sensor data, and the resources of the mobile device.

6. The system as recited in claim 1, wherein the one or more service hubs request data with a lower compensation cost to assess whether data with a higher compensation cost should be requested.

7. The system as recited in claim 1, wherein at least one of the one or more service hubs is provided by a third-party.

8. The system as recited in claim 1, wherein the one or more service hubs includes at least one caching service hub to store historic data.

9. The system as recited in claim 1, wherein the system includes a secure datacenter to regulate communication between the one or more mobile devices and the one or more service hubs.

10. A system for the exchange of sensor data and its abstractions, comprising:
one or more service hubs, including a first service hub, wherein the one or more service hubs receive sensor data from at least one of a lower-level service hub and a mobile device in exchange for compensation; and
a query input configured to receive a query and receive compensation, wherein the query makes requests for sensor data on at least one of the one or more service hubs and receives processed sensor data as a context of at least one user of a mobile device in exchange for compensation,
wherein the first service hub is configured to:
responsive to a request for processed sensor data, request sensor data from one or more mobile devices by sending a request to be scheduled by an application executed on the one or more mobile devices, wherein the request is scheduled such that compensation received is maximized for the user and in accordance with user preferences, and
process the sensor data and return the processed sensor data to at least one of the query and a higher-level service hub.

11. The system as recited in claim 10, wherein data with a lower compensation cost is requested to assess whether data with a higher compensation cost should be requested.

12. The system as recited in claim 10, wherein at least one of the one or more service hubs is provided by a third-party.

13. The system as recited in claim 10, wherein the one or more service hubs includes at least one caching service hub to store historic data.

14. A method for the exchange of sensor data and its abstractions, comprising:
providing one or more service hubs, including a first service hub;
receiving a query that makes requests for sensor data on at least one of the one or more service hubs;
the first service hub, responsive to a request for processed sensor data, requesting sensor data from one or more mobile devices by sending a request to be scheduled by an application executed on the one or more mobile devices;
processing the sensor data on the first service hub and returning the processed sensor data to at least one of the query and a higher-level service hub; and
receiving processed sensor data to the query as a context of at least one user of a mobile device.

15. The method as recited in claim 14, wherein:
receiving a query further includes receiving compensation;
the one or more service hubs receives sensor data from at least one of a lower-level service hub and the one or more mobile devices in exchange for compensation; and
receiving processed sensor data to the query further includes receiving processed sensor data in exchange for compensation.

16. The method as recited in claim 14, wherein the request is scheduled such that compensation is maximized for the user.

17. The method as recited in claim 14, wherein the request is scheduled in accordance with user preferences of the mobile device.

18. The method as recited in claim 14, wherein the one or more service hubs request data with a lower compensation cost to assess whether data with a higher compensation cost should be requested.

19. The method as recited in claim 14, wherein at least one of the one or more service hubs is provided by a third-party.

20. A computer readable storage medium comprising a computer readable program, wherein the computer readable program when executed on a computer causes the computer to perform the steps of claim 14.
